(19) United States
(12) Patent Application Publication
(10) Pub. No.: US 2015/0153904 A1
(43) Pub. Date: Jun. 4, 2015

(54) PROCESSING METHOD OF OBJECT IMAGE FOR OPTICAL TOUCH SYSTEM

(71) Applicant: PIXART IMAGING INC., HSIN-CHU COUNTY (TW)

(72) Inventors: HAN-PING CHENG, HSIN-CHU COUNTY (TW); TZUNG-MIN SU, HSIN-CHU COUNTY (TW); CHIH-HSIN LIN, HSIN-CHU COUNTY (TW)

(21) Appl. No.: 14/551,742

(22) Filed: Nov. 24, 2014

(30) Foreign Application Priority Data
Dec. 4, 2013 (TW) 102144729

(51) Int. Cl. G06F 3/042; G06K 9/00; G06F 3/041

(52) U.S. Cl. CPC G06F 3/0421; G06F 3/0418; G06K 9/00389

(57) ABSTRACT

There is provided a processing method of an object image for an optical touch system includes the steps of: capturing, using a first image sensor, a first image frame containing a first object image; capturing, using a second image sensor, a second image frame containing a second object image; generating a polygon image according to the first image frame and the second image frame; and determining a short axis of the polygon image and at least one object information accordingly.

### RELATED APPLICATIONS

The present application is based on and claims priority to Taiwanese Application Number 102144729, filed Dec. 4, 2013, the disclosure of which is hereby incorporated by reference herein in its entirety.

### BACKGROUND

1. Field of the Disclosure

This disclosure generally relates to an input system and, more particularly, to an optical touch system and a processing method of an object image therefor.

2. Description of the Related Art

The conventional optical touch system, such as an optical touch screen, generally has a touch surface, at least two image sensors and a processing unit, wherein field of views of the image sensors encompass the entire touch surface. When a user touches the touch surface with one finger, the image sensors capture an image frame containing one finger image, respectively. The processing unit calculates a two-dimensional coordinate position of the finger corresponding to the touch surface according to positions of the finger image in the image frames. A host then relatively performs an operation, e.g. clicking to select an icon or executing a program, according to the two-dimensional coordinate position.

Referring to FIG. 1a, it shows a conventional optical touch screen 9. The optical touch screen 9 includes a touch surface 90, two image sensors 92 and 92′ and a processing unit 94. The image sensors 92 and 92′ are configured to respectively capture image frames F₉₂ and F₉₂′ looking across the touch surface 90, as shown in FIG. 1b. When a finger 81 touches the touch surface 90, the image sensors 92 and 92′ respectively capture images I₈₁ and I₈₁′ containing the finger 81. The processing unit 94 calculates a two-dimensional coordinate of the finger 81 corresponding to the touch surface 90 according to a one-dimensional coordinate position of the image I₈₁ in the image frame F₉₂ and a one-dimensional coordinate position of the image I₈₁′ in the image frame F₉₂′.

However, the operation principle of the optical touch screen 9 is to calculate a two-dimensional coordinate position where the finger 91 touches the touch surface 90 according to an image position of the finger 81 in each image frame. When a user touches the touch surface 90 with two fingers 81 and 82 simultaneously, as shown in FIG. 1c, the image frames F₉₂ and F₉₂′ captured by the image sensors 92 and 92′ may not show two separated images corresponding to the two fingers 81 and 82 but show one combined image I₈₁+I₈₂ and I₈₁′+I₈₂′ respectively due to the fingers being too close to each other, as shown in FIG. 1d, and the combined images I₈₁+I₈2 and I₈₁′+I₈₂′will lead to misjudgment of the processing unit 94. Therefore, how to separate the merged object image is an important issue.

### SUMMARY

Accordingly, the present disclosure further provides an optical touch system and a processing method of an object image therefor that calculate an area, a long axis and a short axis of the object image.

The present disclosure provides an optical touch system and a processing method of an object image therefor that identify a single-Finger image or a two-combined-finger image of a user from an object image captured by image sensors of the optical touch system, and perform image separation.

The present disclosure further provides an optical touch system a nd a processing method of an object image therefor that have an effect of avoiding mistakes for the optical touch system.

The present disclosure provides a processing method of an object image for an optical touch system. The optical touch system includes at least two image sensors configured to capture image frames looking across a touch surface and containing at least one object operating on the touch surface and a processing unit configured to process the image frames. The processing method includes the steps of: capturing, using a first image sensor, a first image frame containing a first object image; capturing, using a second image sensor, a second image frame containing a second object image; generating, using the processing unit, a polygon image according to the first image frame and the second image frame; and determining, using the processing unit, a short axis of the polygon image and at least one object information accordingly.

The present disclosure further provides a processing method of an object image for an optical touch system. The optical touch system includes at least two image sensors configured to successively capture image frames looking across a touch surface and containing at least one object operating on the touch surface and a processing unit configured to process the image frames. The processing method includes the steps of: respectively capturing, using the image sensors, a first image frame looking across the touch surface and containing at least one object image at a first time; respectively capturing, using the image sensors, a second image frame looking across the touch surface and containing at least one object image at a second time; generating a polygon image according to the second image frames when the processing unit identifies a number of object at the second time is smaller than that at the first time according to the first image frames and the second image frames; and determining, using the processing unit, a short axis of the polygon image and at least one object information accordingly.

The present disclosure further provides a processing method of an object image for an optical touch system. The optical touch system includes at least two image sensors configured to successively capture image frames looking across a touch surface and containing at least one object operating on the touch surface and a processing unit configured to process the image frames. The processing method includes the steps of: respectively capturing, using the image sensors, a first image frame looking across the touch surface and containing at least one object image at a first time; respectively capturing, using the image sensors, a second image frame looking across the touch surface and containing at least one object image at a second time; generating a polygon image according to the second image frames when the processing unit identifies that an area increment between the object image captured at the second time and the object image captured at the first time by a same image sensor is larger than a variation threshold; and determining, using the processing unit, a short axis of the polygon image and at least one object information accordingly.

In some embodiments, a processing unit determines whether to separate the polygon image according to an area of the polygon image and calculates a coordinate position of at least one of two separated object images after image separation.

In some embodiments, a processing unit determines whether to separate the polygon image according to a ratio of a long axis to the short axis of the polygon image and calculates a coordinate position of at least one of two separated object images after image separation.

In some embodiments, a processing unit determines whether to separate the polygon image according to an area of the polygon image and a ratio of a long axis to the short axis of the polygon image and calculates a coordinate position of at least one of two separated object images after image separation.

In some embodiments, the short axis is a straight line having the largest summation of perpendicular distances from the straight line to vertexes of the polygon image among all straight lines passing through a center of gravity or a geometric center of the polygon image; and the long axis is a straight line having the smallest summation of perpendicular distances from the straight line to vertexes of the polygon image among all straight lines passing through the center of gravity or the geometric center of the polygon image.

The optical touch system according to the embodiment of the present disclosure accurately identifies that a user performs touched operation with a single finger or two adjacent fingers in an object image captured by image sensors of the optical touch system according to calculating an area, a long axis and a short axis of the object image in a mapped two dimensional space of a touch surface. In addition, judgment accuracy is improved through identifying variation of image numbers and areas of object images in successively image frames.

### BRIEF DESCRIPTION OF THE DRAWINGS

Other objects, advantages, and novel features of the present disclosure will become more apparent from the following detailed description when taken in conjunction with the accompanying drawings.

FIG. 1a is a schematic diagram of operation for a conventional optical touch screen.

FIG. 1b is a schematic diagram of image frames containing the finger image captured by the image sensors of the optical touch screen of FIG. 1a.

FIG. 1c is a schematic diagram of operation for the conventional optical touch screen.

FIG. 1d is a schematic diagram of image frames containing images of two fingers captured by the image sensors of the optical touch screen of FIG. 1c.

FIG. 2a is a schematic diagram of an optical touch system according to one embodiment of the present disclosure.

FIG. 2b is a schematic diagram of image frames captured by the image sensors of FIG. 2a.

FIG. 2c is a schematic diagram of a two dimensional space corresponding to the touch surface of FIG. 2a.

FIG. 2d is an enlarged view of the polygon image of FIG. 2c.

FIG. 2e is a flow chart of a processing method of an object image for an optical touch system according to a first embodiment of the present disclosure.

FIG. 3a is a schematic diagram of a gray value profile corresponding to a pixel array of the image sensor of the optical touch system according to the present disclosure.

FIG. 3b is a schematic diagram of another gray value profile corresponding to the pixel array of the image sensor of the optical touch system according to the present disclosure.

FIG. 4 is a flow chart of a processing method of an object image for an optical touch system according to a second embodiment of the present disclosure.

FIG. 5a is a schematic diagram of an optical touch system according to another embodiment of the present disclosure.

FIG. 5b is a schematic diagram of image frames captured by the image sensors of the optical touch system of FIG. 5a.

FIG. 6 is a flow chart of a processing method of an object image for an optical touch system according to a third embodiment of the present disclosure.

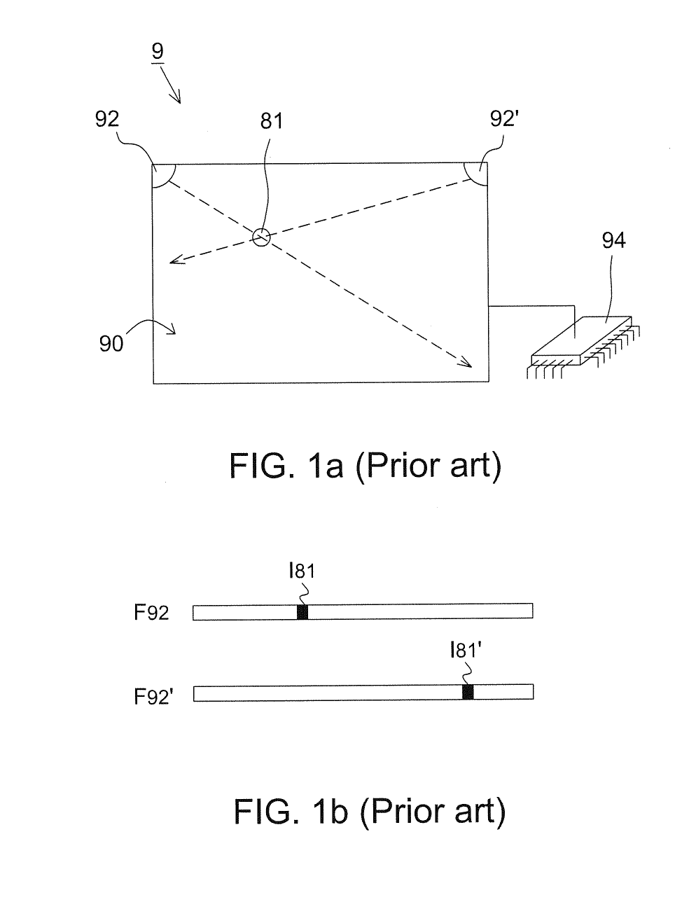

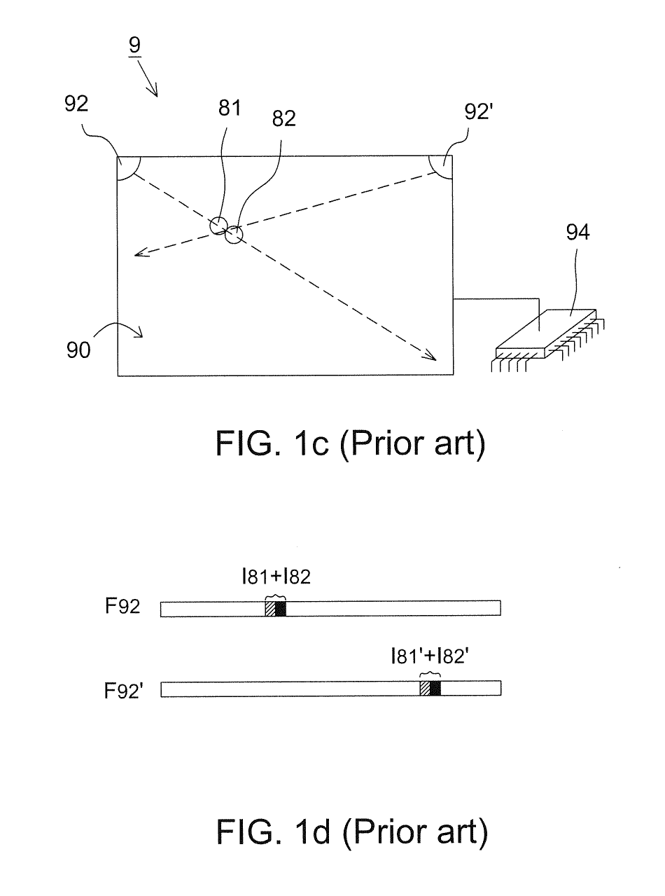

### DETAILED DESCRIPTION OF THE EMBODIMENT

It should be noted that, wherever possible, the same reference numbers will be used throughout the drawings to refer to the same or like parts.

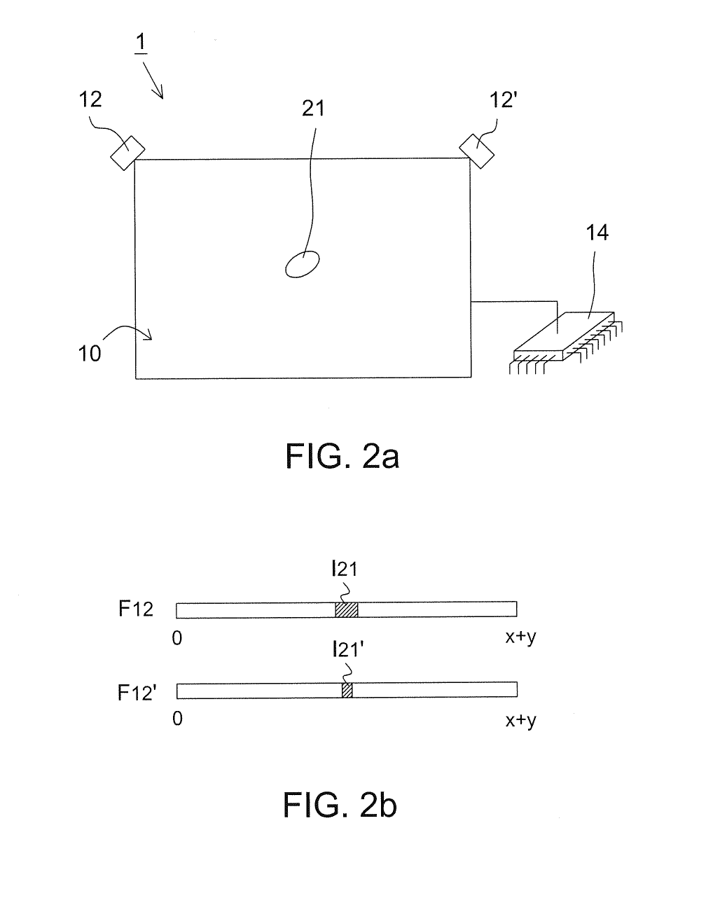

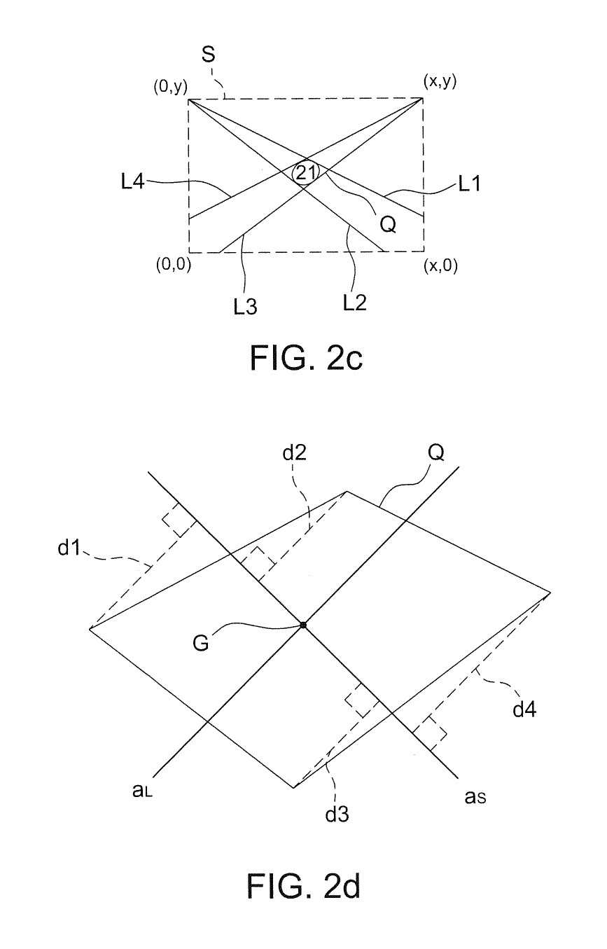

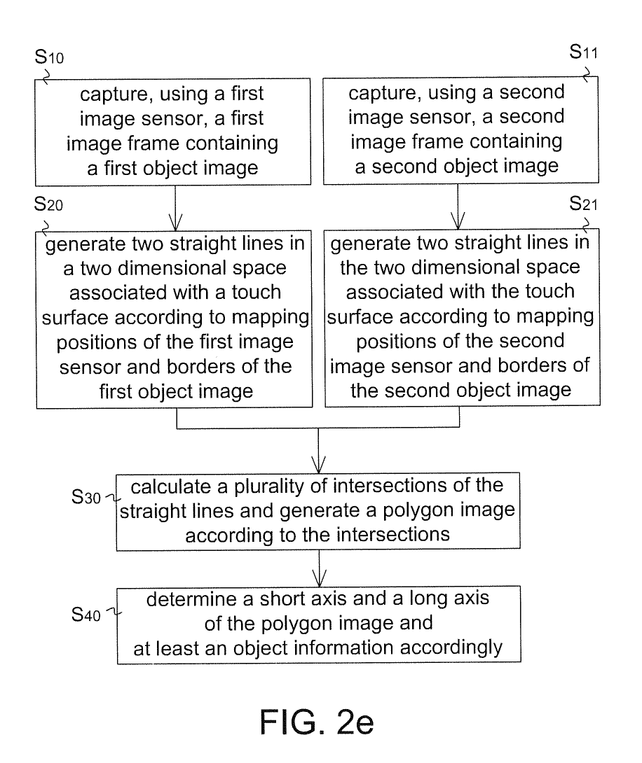

FIG. 2a is a schematic diagram of an optical touch system 1 according to one embodiment of the present disclosure. The optical touch system 1 includes a touch surface 10, at least two image sensors (two image sensors 12 and 12′ shown herein) and a processing unit 14, wherein the processing unit 14 may be implemented by software or hardware. The image sensors 12 and 12′ are electrically connected to the processing unit 14. A user (not shown) approaches or touches the touch surface 10 with a finger or a touch control device (e.g. a touch pen). The processing unit 14 then calculates a position or a position variation of the finger or the touch control device corresponding to the touch surface 10 according to image frames captured by the image sensors 12 and 12′. A host (not shown) accordingly performs corresponding operations, e.g. clicking to select an icon or executing a program. The optical touch system 1 is adopted in a white board, a projection screen, a smart TV, a computer system or the like, and provides a user interface to interact with users.

It should be mentioned that the following optical touch system 1 according to each embodiment of the present disclosure includes a first image sensor 12 and a second image sensor 12′ for simplifying description, but the present disclosure is not limited thereto. In some embodiments, the optical touch system 1 has four image sensors disposed at four corners of the touch surface 10. In some embodiments, the optical touch system 1 has more than four image sensors disposed at four corners or four margins of the touch surface 10. The number of image sensors depends on the size of the touch surface 10 and actual applications.

In addition, it is appreciated that the optical touch system 1 further has at least one system light source (e.g. disposed at four margins of the touch surface 10) to illuminate field of views of the image sensors 12 and 12′ or the field of views are illuminated by an external light source.

The touch surface 10 is configured to provide for at least one object to operate thereon. The image sensors 12 and 12′ are configured to capture image frames (containing or not containing the image of the touch surface) looking across the touch surface 10. The touch surface 10 is a surface of a touch screen or a suitable object. The optical touch system 1 may include a display so as to relatively show an operating status of a user.

The image sensors 12 and 12′ are respectively configured to capture an image frame looking across the touch surface 10 and containing at least one object image, wherein the image sensors 12 and 12′ are preferably disposed at corners of the touch surface 10 so as to cover an operable range of the touch surface 10. It should be mentioned that when the optical touch system 1 has only two image sensors, the image sensors 12 and 12′ are preferably disposed at two corners of an identical margin of the touch surface 10 so as to avoid mistakes when a plurality of objects are located between the image sensors 12 and 12′ and blocking each other.

The processing unit 14 is, for example, a digital signal processor (DSP) or other processing devices that are configured to process image data. The processing unit 14 is configured to respectively generate two straight lines in a two dimensional space associated with the touch surface 10 according to mapping positions of each one of the image sensors 12 and 12′ and borders of the object image in the associated image frames, calculate a polygon image generated by a plurality of intersections of the straight lines, calculate a short axis and a long axis of the polygon image and perform image separation accordingly.

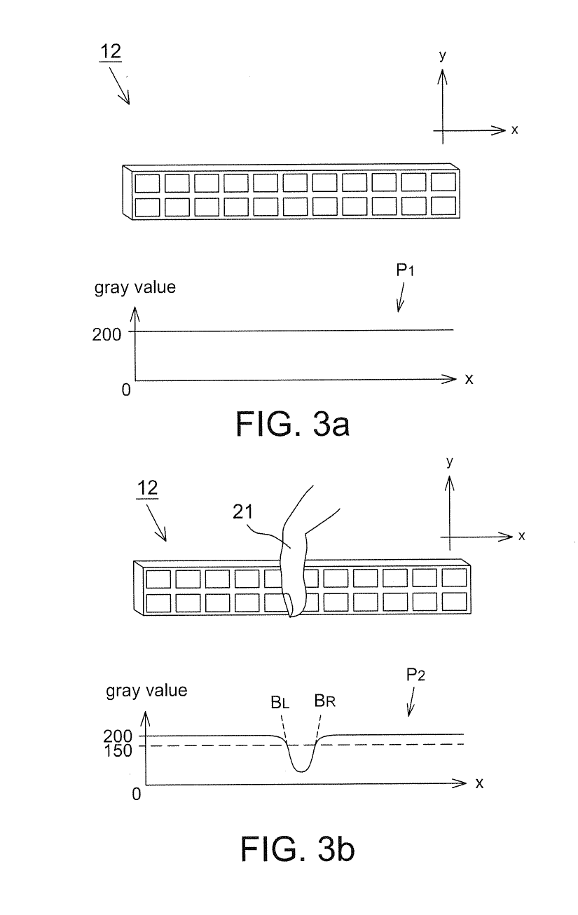

Since the image sensors 12 and 12′ of the present embodiment have the same function, only the image sensor 12 is described in the following. The image sensor 12 has a pixel array, e.g. an 11×2 pixel array of the image sensor 12 as shown in FIG. 3a, but not limited thereto. Since the image sensor 12 is configured to capture an image frame looking across the touch surface 10, the size of the pixel array is determined according to the size of the touch surface 10 and the accuracy required by the optical touch system 1. On the other hand, the image sensor 12 is preferably an active sensor, e.g. a complementary metal-oxide-semiconductor (CMOS), but not limited thereto.

It should be mentioned that although FIG. 3a only shows the 11×2 pixel array to represent the image sensor 12, the image sensor 12 may further include a plurality of charge storage units (not shown) configured to store photosensitive information of the pixel array. The processing unit 14 then reads the photosensitive information from the charge storage units in the image sensor 12 and transfers to a gray value profile accordingly, wherein the gray value profile is calculated by summing gray values of the entire or a part of the photosensitive information of each column of the pixel array. When the image sensor 12 captures an image frame without any objects, as shown in FIG. 3a, the processing unit 14 calculates a gray value profile P1 according to the image frame. Since each pixel in the pixel array is exposed to light, the gray value profile P1 is substantially a straight line. When the image sensor 12 captures an image frame containing an object (e.g. the finger 21), as shown in FIG. 3b, the processing unit 14 calculates a gray value profile P2 according to the image frame, wherein a recess of the gray value profile P2 (e.g. where the gray value is smaller than 200) is associated with a position where the finger 21 touches the touch surface 10. The processing unit 14 determines two borders B_{L} and B_{R} of the recess according to a gray value threshold (e.g. gray value of 150). Therefore, the processing unit 14 calculates a number, locations, image widths and areas of objects in captured images by the image sensor 12 according to a number and locations of borders of a gray value profile.

Since the method of identifying the number and location of objects according to an image frame captured by an image sensor is well known, and the method is not limited to the gray value profile mentioned above, details thereof are not described herein. In addition, to simplify the description, an image frame captured by the image sensor 12 and border locations of object images in the image frame are directly used in the embodiment of the present disclosure to describe the number and location of objects, calculated by the processing unit 14, in the captured image frame corresponding to the image sensor 12.

Referring to FIG. 2b, it is a schematic diagram of a first image frame F₁₂ captured by the first image sensor 12 of FIG. 2a and a second image frame F₁₂′ captured by the second image frame 12′ of FIG. 2a. The first image frame F₁₂ contains a first object image I₂₁ and has a first numerical range, e.g. from 0 to x+y (x and y are integers greater than 0), so as to form a one-dimensional space. The second image frame F₁₂′ contains a second object image I₂₁′ and has a second numerical range, e.g. from 0 to x+y, so as to form a one-dimensional space. It is appreciated that the numerical ranges may be determined by the size of the touch surface 10.

Referring to FIGS. 2b and 2c together, a two dimensional space S corresponding to the touch surface 10 is mapped according to the first image sensor 12, the second image sensor 12′ as well as the numerical ranges of the image frames F12 and F12′ as shown in FIG. 2c. More specifically speaking, for example when a two-dimensional coordinate of the first image sensor 12 corresponding to the two dimensional space S is determined as (0, y) and a two-dimensional coordinate of the second image sensor 12′ corresponding to the two dimensional space S is determined as (x, y), the first numerical range from 0 to x+y of the first image frame F₁₂ corresponds to, for example, two-dimensional coordinates from (0, 0), (1, 0), (2, 0) . . . (x, 0) to (x, 1), (x, 2), (x, 3) . . . (x, y) of the two dimensional space S, and the second numerical range from 0 to x+y of the second image frame F₁₂′ corresponds to, for example, two-dimensional coordinates from (x, 0), (x-1, 0), (x-2, 0) . . . (0, 0) to (0, 1), (0, 2), (0, 3) . . . (0, y) of the two dimensional space S, but the present disclosure is not limited thereto. The corresponding relationship between values of the image frame and coordinate positions of the two dimensional space depends on actual applications.

FIG. 2e is a flow chart of a processing method of an object image for an optical touch system according to a first embodiment of the present disclosure, which includes the following steps of: capturing, using a first image sensor, a first image frame containing a first object image (step S₁₀); capturing, using a second image sensor, a second image frame containing a second object image (step S₁₁); generating, using a processing unit, two straight lines in a two dimensional space associated with a touch surface according to mapping positions of the first image sensor and borders of the first object image in the first image frame in the two dimensional space (step S₂₀); generating, using the processing unit, two straight lines in the two dimensional space according to mapping positions of the second image sensor and borders of the second object image in the second image frame in the two dimensional space (step S₂₁); calculating, using the processing unit, a plurality of intersections of the straight lines and generating a polygon image according to the intersections (step S₃₀); and determining, using the processing unit, a short axis and a long axis of the polygon image and determining at least one object information accordingly (step S₄₀). It should be mentioned that the steps S₂₀, S₂₁ and S₃₀ are intended to show one implementation for calculating a polygon image according to the first image frame and the second image frame, but the method of calculating the polygon image is not limited to that disclosed by the present embodiment.

Referring to FIGS. 2a-2e together, when the finger 21 touches or approaches the touch surface 10 of the optical touch system 1, the first image sensor 12 captures the first image frame F₁₂, and the first image frame F₁₂ contains a first object image I₂₁ of the finger 21. At the same time, the second image sensor 12′ captures the second image frame F₁₂′, and the second image frame F₁₂′ contains a second object image I₂₁′ of the finger 21. As mentioned above, after generating the two dimensional space S according to the image sensors 12 and 12′ and the image frames F₁₂ and F₁₂′, the processing unit 14 generates two straight lines L1 and L2 according to mapping positions of the first image sensor 12 and borders of the first object image I₂₁ in the two dimensional space S. Similarly, the processing unit 14 generates two straight lines L3 and L4 according to mapping positions of the second image sensor 12′ and borders of the second object image I₂₁′ in the two dimensional space S. Then, the processing unit 14 calculates a plurality of intersections according to linear equations of the straight lines L1-L4 and generates a polygon image, for example a polygon image Q shown in FIG. 2c, according to the intersections. The processing unit 14 further calculates a short axis a_{S} and a long axis a_{L} of the polygon image Q, and determines at least one object information accordingly, wherein the short axis a_{S} is configured to perform image separation.

It should be mentioned that the short axis a_{S} according to the embodiment of the present disclosure is defined as a straight line having the smallest summation of perpendicular distances from the straight line to vertexes of the polygon image Q among all straight lines passing through a center of gravity or a geometric center (i.e. centroid) of the polygon image Q. For example, FIG. 2d shows that the polygon image Q has a center of gravity G, and the perpendicular distances from the short axis a_{S}, which passes through the center of gravity G, to each vertex of the polygon image Q are shown to be d1-d4 respectively, wherein summations of perpendicular distances from the vertexes of the polygon image Q to other straight lines passing through the center of gravity G are all smaller than the summation of d1-d4. The long axis a_{L} is defined as a straight line having the largest summation of perpendicular distances from the straight line to vertexes of the polygon image Q among all straight lines passing through the center of gravity or the geometric center of the polygon image Q, but not limited thereto. In addition, a long axis and a short axis of a polygon may be calculated by using other conventional methods, e.g. eigenvector calculation, principal component analysis and linear regression analysis, and thus details thereof are not described herein.

In one aspect, the processing unit 14 calculates an area of the polygon image Q and compares the area with an area threshold. When the area is larger than the area threshold, it means that the polygon image Q is a merged object image, and the processing unit 14 performs image separation along the short axis aₛ passing through the center of gravity G or the geometric center of the polygon image Q. It should be mentioned that if the image separation is performed by the present aspect, the processing unit 14 may only calculate the short axis a_{S} but not calculate the long axis a_{L} so as to save the system resource.

The area threshold is preferably between contact areas corresponding to a single finger and two fingers with which the user touches the touch surface 10 respectively, but not limited thereto. The area threshold is previously stored in a memory before the optical touch system 1 leaves the factory. The optical touch system 1 further provides a user interface for the user to perform fine-tuning of the area threshold.

In another aspect, the processing unit 14 calculates a ratio of the long axis a_{L}, to the short axis a_{S} of the polygon image Q and compares the ratio with a ratio threshold. When the ratio is larger than the ratio threshold, it means that the polygon image Q is a merged object image, and the processing unit 14 performs image separation along the short axis a_{S} passing through the center of gravity G or the geometric center of the polygon image Q.

It should be mentioned that when the ratio is obtained by dividing the long axis a_{L} by the short axis a_{S}, the long axis a_{L} is referred to a line length of the long axis a_{L} located inside the polygon image Q. Similarly, the short axis a_{S} is referred to a line length of the short axis a_{S} located inside the polygon image Q. In addition, the ratio threshold is set to 2.9 or other values, and is previously stored in a memory before the optical touch system 1 leaves the factory. Or, a user interface is provided for the user to perform fine-tuning of the ratio threshold.

In another aspect, the processing unit 14 identifies whether the area is larger than the area threshold and whether the ratio is larger than the ratio threshold so as to improve the identification accuracy. When the above conditions are all satisfied, the processing unit 14 performs image separation along the short axis a_{S} passing through the center of gravity G or the geometric center of the polygon image Q. Furthermore, the ratio threshold is inversely correlated with the area. For example, when the area of the polygon image becomes smaller, the ratio threshold is set between 2.5 and 3.5 so that the image separation is performed only if the ratio of the long axis a_{L} to the short axis a_{S} is larger than 2.9. When the area of the polygon image becomes bigger, the ratio threshold is set between 1.3 and 2.5 so that the image separation is performed as long as the ratio is larger than 1.5. Accordingly, the accuracy for identifying whether to perform image separation is improved.

In addition, since the polygon image Q may be divided into two polygon images by the short axis a_{S}, the processing unit 14 in the above aspects further determines the at least one object information, wherein the object information is a coordinate position of at least one separated image. That is to say, the processing unit 14 calculates a coordinate of at least one of two separated object images formed after the image separation and performs post-processing accordingly, and the required post-processing is determined according to the application thereof.

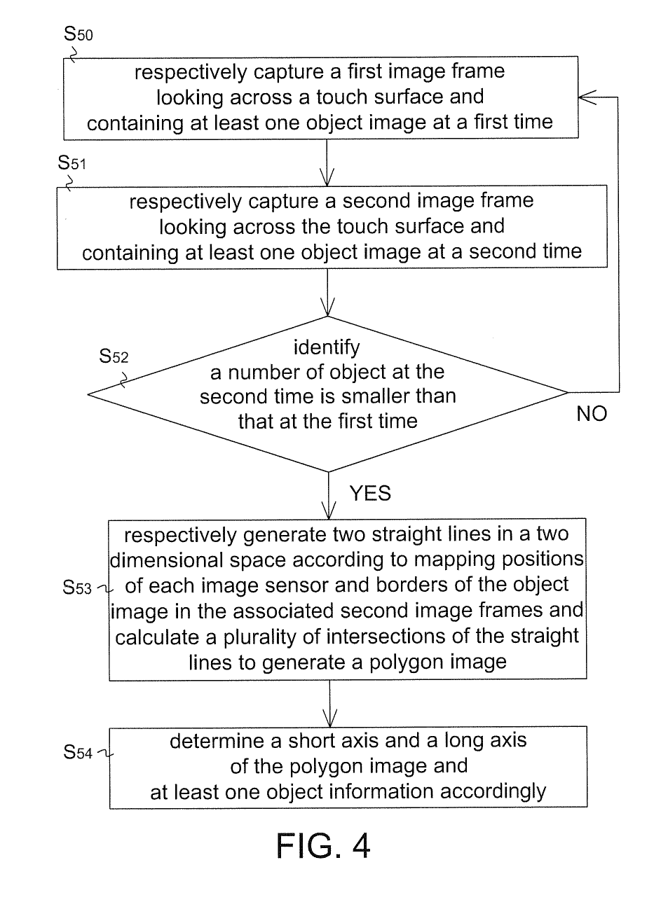

FIG. 4 is a flow chart of a processing method of an object image for an optical touch system according to a second embodiment of the present disclosure, which includes the following steps: respectively capturing, using a plurality of image sensors, a first image frame looking across a touch surface and containing at least one object image at a first time (step S₅₀); respectively capturing, using the image sensors, a second image frame looking across the touch surface and containing at least one object image at a second time (step S₅₁); identifying, using a processing unit, whether a number of objects at the second time is smaller than that at the first time according to the first image frames and the second image frames (step S₅₂); when the processing unit identifies the number of objects at the second time is smaller than that at the first time according to the first image frames and the second image frames, respectively generating two straight lines in a two dimensional space according to mapping positions of each of the image sensors and borders of the object image in the associated second image frames and calculating a plurality of intersections of the straight lines to generate the polygon image (step S₅₃); and determining, using the processing unit, a short axis and a long axis of the polygon image and determining at least one object information (step S₅₄). It should be mentioned that the step S₅₃ is intended to show one implementation for calculating a polygon image according to the first image frame and the second image frame, but the method of calculating the polygon image is not limited to those disclosed in the present embodiment.

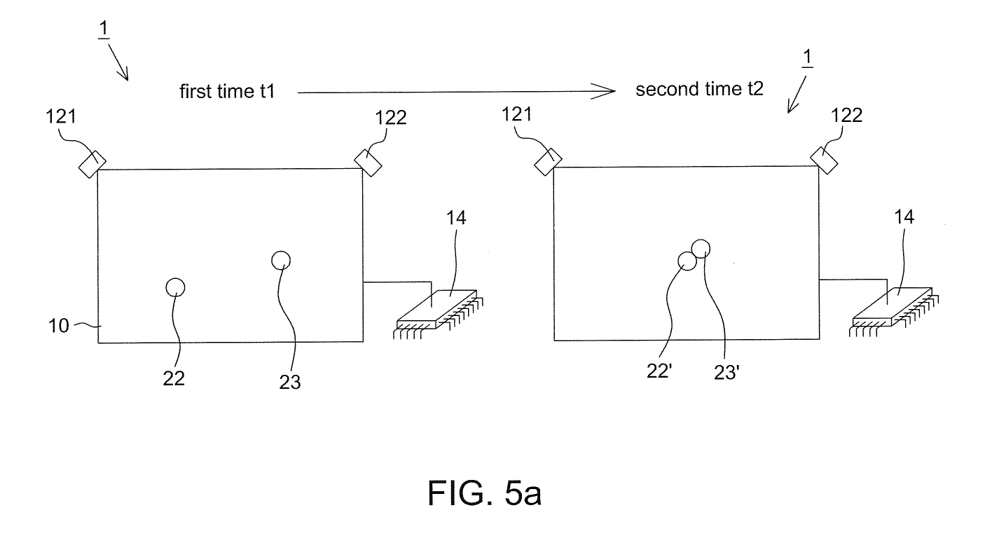

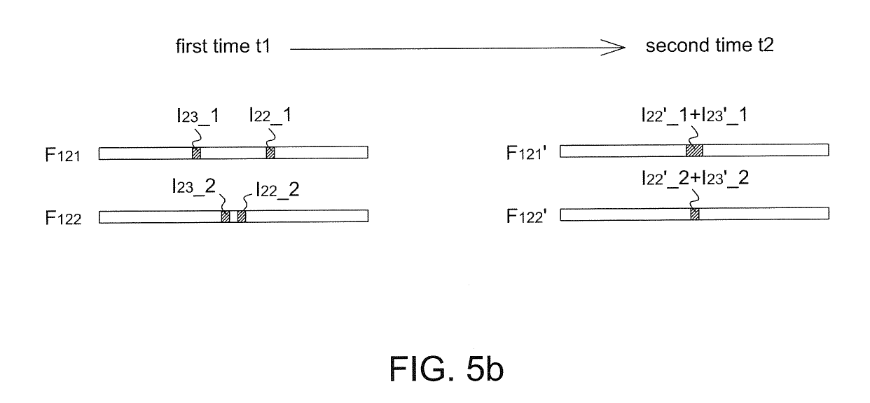

Referring to FIGS. 4, 5a and 5b together, it is assumed that a user touches or approaches the touch surface 10 with two fingers 22 and 23 at a first time t1,and combines the fingers 22′ and 23′ to touch or approach the touch surface 10 at a second time t2, as shown in FIG. 5a. Then, two image sensors 121 and 122 of the optical touch system 1 successively capture first image frames F₁₂₁ and F₁₂₂ and second image frames F₁₂₁′ and F₁₂₂′ at the first time t1 and the second time t2 respectively, as shown in FIG. 5b, wherein the processing unit 14 identifies the number of objects as 2 according to first object images and I₂₂_{_{—}}1 and I₂₃_{_{—}}1 in the first image frame F₁₂₁. Similarly, the processing unit 14 respectively identifies the numbers of objects as 2, 1 and 1 according to the first image frame F₁₂₂ and the second image frames F₁₂₁′ and F₁₂₂′.

Then, the processing unit 14 identifies a number of objects at the second time t2 is smaller than that at the first time t1 according to the first and second image frames F₁₂₁, F₁₂₂, F₁₂₁′ and F₁₂₂′. For example, when the number of objects of the first image frame F₁₂₁′ at the second time t2 is smaller than that of the first image frame F₁₂₁ at the first time t1 or when the number of objects of the second image frame F₁₂₂′ at the second time t2 is smaller than that of the second image frame F₁₂₂ at the first time t1, the processing unit 14 respectively generates two straight lines in a two dimensional space according to mapping positions of each of the image sensors 121 and 122 and borders of the object image in the associated second image frames F₁₂₁′ and F₁₂₂′, and calculates a plurality of intersections of the straight lines to generate a polygon image. Finally, the processing unit 14 calculates a short axis and a long axis of the polygon image and separates the polygon image accordingly. It should be mentioned that the method of calculating the polygon image, the long axis and the short axis thereof in the two dimensional space according to the second embodiment of the present disclosure (i.e. the steps of S₅₃ and S₅₄) is identical to that according to the first embodiment (referring to FIGS. 2c and 2d), and thus details thereof are not described herein.

In one aspect, when a number of objects at the second time t2 is smaller than that at the first time t1 and when an area of the polygon image is larger than an area threshold, the processing unit 14 performs image separation along a short axis passing through a center of gravity or a geometric center of the polygon image.

In another aspect, when a number of objects at the second time t2 is smaller than that at the first time t1 and when a ratio of a long axis to a short axis of the polygon image is larger than a ratio threshold, the processing unit 14 performs image separation along the short axis passing through a center of gravity or a geometric center of the polygon image.

In another aspect, the processing unit 14 identifies whether the area is larger than the area threshold and whether the ratio is larger than the ratio threshold. When the above two conditions are all satisfied and when a number of objects at the second time t2 is smaller than that at the first time t1, the processing unit 14 performs image separation along the short axis passing through a center of gravity or a geometric center of the polygon image. Furthermore, the ratio threshold is inversely correlated with the area so that the accuracy for identifying whether to perform image separation is improved.

In the above aspects, the processing unit 14 further determines the at least one object information, wherein the object information is a coordinate position of at least one separated image. For example, after dividing the polygon image Q into two polygon images along the short axis a_{S}, the processing unit 14 calculates a coordinate of at least one of two separated object images formed after image separation and performs post-processing accordingly, but not limited thereto.

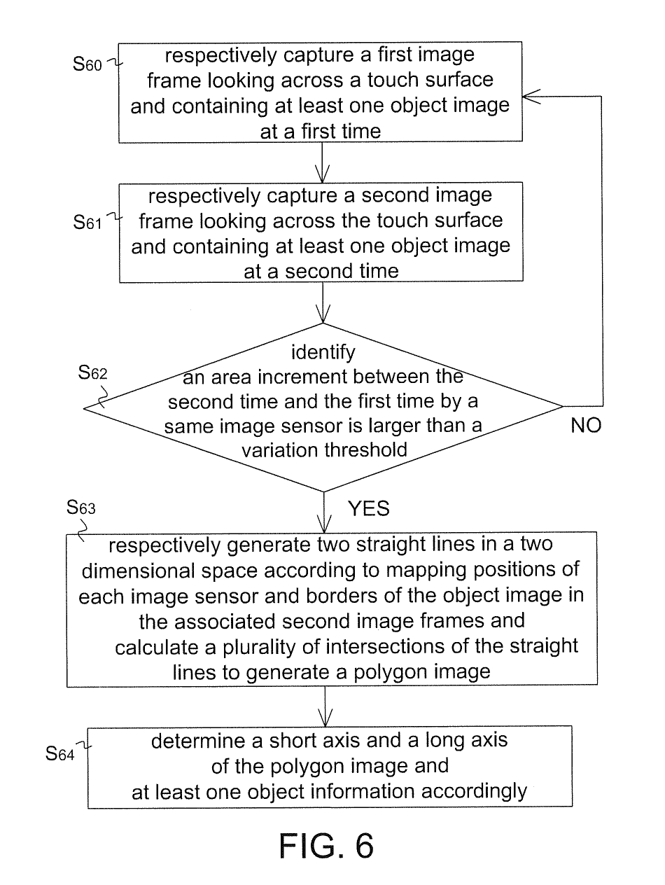

FIG. 6 is a flow chart of a processing method of an object image for an optical touch system according to a third embodiment of the present disclosure, which includes the following steps: respectively capturing, using a plurality of image sensors, a first image frame looking across a touch surface and containing at least one object image at a first time (step S₆₀); respectively capturing, using the image sensors, a second image frame looking across the touch surface and containing at least one object image at a second time (step S₆₁); identifying, using a processing unit, whether an area increment between the object image captured at the second time and the object image captured at the first time by a same image sensor is larger than a variation threshold (step S₆₂); when the processing unit identifies that an area increment between the object image captured at the second time and the object image captured at the first time by a same image sensor is larger than a variation threshold, respectively generating two straight lines in a two dimensional space according to mapping positions of each of the image sensors and borders of the object image in the associated second image frames and calculating a plurality of intersections of the straight lines to generate a polygon image (step S₆₃); and determining, using the processing unit, a short axis and a long axis of the polygon image and determining at least one object information accordingly (step S₆₄). It should be mentioned that the step S₆₃ is intended to show one implementation for calculating a polygon image according to the first image frame and the second image frame, but the method of calculating the polygon image is not limited to those disclosed in the present embodiment.

The difference between the third embodiment and the second embodiment of the present disclosure is that the processing unit 14 according to the second embodiment identifies the number of objects of the image frames as a precondition. For example, the next step (step S₅₃) is entered when the step S₅₂ in FIG. 4 is satisfied; otherwise, go back to the step S₅₀. The precondition means that if the image frame captured at a previous time contains two object images, there is a higher possibility that the image frame captured at a current time also contains two object images. Whether to perform image separation is further confirmed according to an area of the object image or a ratio of the long axis to the short axis of the object image. In the third embodiment, referring to FIGS. 5a, 5b and 6 together, the processing unit 14 identifies whether an area increment between the object image captured at the second time t2 and the object image captured at the first time t1 by a same image sensor (i.e. the first image sensor 121 or the second image sensor 122) is larger than a variation threshold in the step S₆₂. And when the area increment is larger than the variation threshold, the next step (step S₆₃) is then entered; otherwise, go back to the step S₆₀.

For example, the first image frame F₁₂₁ captured at the first time tl by the first image sensor 121 has two object images I₂₂_{_{—}}1 and I₂₃_{_{—}}1, and the second image frame F₁₂₁′ captured at the second time t2 by the first image sensor 121 has one object image I₂₂′_1+I₂₃′_1. The processing unit 14 then obtains a first area increment by subtracting the area of the object image ₁₂₂ (or the area of the object image I₂₃) from the area of the object image I₂₂′_1+I₂₃′_1. Similarly, the processing unit 14 also calculates the areas of the object images of the image frames F₁₂₂ and F₁₂₂′ respectively captured at the first time t1 and the second time t2 by the second image sensor 122 and calculates a second area increment. Then, when the processing unit 14 identifies that the first area increment is larger than the variation threshold or the second area increment is larger than the variation threshold, the optical touch system 1 may enter the step S₆₃.

It should be mentioned that when the first image sensor 121 and the second image sensor 122 arranged in the optical touch system 1 are the same type, heights of the image frames F₁₂₁, F₁₂₂, F₁₂₁′ and F₁₂₂′ captured by the image sensors 121 and 122 are identical. Therefore, in addition to calculating areas of the object images, the processing unit 14 may only calculates widths of the object images. That is to say, the processing unit 14 identifies whether a width increment between the object image captured at the second time t2 and the object image captured at the first time t1 by a same image sensor is larger than a variation threshold. When the width increment is larger than the variation threshold, the next step (step S₆₃) is then entered; otherwise, go back to the step S₆₀.

The condition of identifying whether to separate the polygon image along the short axis passing through a center of gravity or a geometric center of the polygon image (i.e. the steps of S₆₃ and S₆₄) according to the third embodiment of the present disclosure is identical to the above aspects of the first embodiment or the second embodiment, e.g. calculating an area or a ratio of the long axis to the short axis of the polygon image, and thus details thereof are not described herein.

When the merged object image is separated, the processing unit 14 further calculates image positions according to the separated object images respectively. That is to say, two object positions are still obtainable from a single merged object image. The processing unit 14 calculates a coordinate of at least one of two separated object images formed after image separation and performs post-processing accordingly.

As mentioned above, the conventional optical touch system cannot identify a merged object image formed by two adjacent fingers thereby causing the problem of misoperation. Therefore, the present disclosure provides an optical touch system (FIGS. 2a and 5a) and a processing method therefor (FIGS. 2e, 4 and 6) by calculating the area, long axis and short axis of the image to process object images. It is able to identify that a user is operating with a single finger or two adjacent fingers according to an object image captured by image sensors of the optical touch system.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A processing method of an object image for an optical touch system, the optical touch system comprising at least two image sensors configured to capture image frames looking across a touch surface and containing at least one object operating on the touch surface and a processing unit configured to process the image frames, the processing method comprising:
capturing, using a first image sensor, a first image frame containing a first object image;
capturing, using a second image sensor, a second image frame containing a second object image;
generating, using the processing unit, a polygon image according to the first image frame and the second image frame; and
determining, using the processing unit, a short axis of the polygon image and determining at least one object information accordingly.

2. The processing method as claimed in claim 1, further comprising:
generating two straight lines in a two dimensional space associated with the touch surface according to mapping positions of the first image sensor and borders of the first object image in the first image frame in the two dimensional space;
generating two straight lines in the two dimensional space according to mapping positions of the second image sensor and borders of the second object image in the second image frame in the two dimensional space; and
calculating a plurality of intersections of the straight lines and generating the polygon image according to the intersections.

3. The processing method as claimed in claim 1, further comprising:
calculating an area of the polygon image; and
separating the polygon image along the short axis to determine the at least one object information when the area is larger than an area threshold, wherein the object information is a coordinate position of at least one separated image.

4. The processing method as claimed in claim 1, further comprising:
calculating a long axis of the polygon image;
calculating a ratio of the long axis to the short axis; and
separating the polygon image along the short axis to determine the at least one object information when the ratio is larger than a ratio threshold, wherein the object information is a coordinate position of at least one separated image.

5. The processing method as claimed in claim 1, further comprising:
calculating a long axis of the polygon image;
calculating an area of the polygon image;
calculating a ratio of the long axis to the short axis; and
separating the polygon image along the short axis to determine the at least one object information when the area is larger than an area threshold and the ratio is larger than a ratio threshold, wherein the object information is a coordinate position of at least one separated image.

6. The processing method as claimed in claim 5, wherein the ratio threshold is inversely correlated with the area.

7. A processing method of an object image for an optical touch system, the optical touch system comprising at least two image sensors configured to successively capture image frames looking across a touch surface and containing at least one object operating on the touch surface and a processing unit configured to process the image frames, the processing method comprising:
respectively capturing, using the image sensors, a first image frame looking across the touch surface and containing at least one object image at a first time;
respectively capturing, using the image sensors, a second image frame looking across the touch surface and containing at least one object image at a second time;
generating a polygon image according to the second image frames when the processing unit identifies a number of object at the second time is smaller than that at the first time according to the first image frames and the second image frames; and
determining, using the processing unit, a short axis of the polygon image and at least one object information accordingly.

8. The processing method as claimed in claim 7, further comprising:
respectively generating two straight lines in a two dimensional space according to mapping positions of each of the image sensors and borders of the object image in the associated second image frames; and
calculating a plurality of intersections of the straight lines to generate the polygon image.

9. The processing method as claimed in claim 7, further comprising:
calculating an area of the polygon image; and
separating the polygon image along the short axis to determine the at least one object information when the area is larger than an area threshold, wherein the object information is a coordinate position of at least one separated image.

10. The processing method as claimed in claim 7, further comprising:
calculating a long axis of the polygon image;
calculating a ratio of the long axis to the short axis; and
separating the polygon image along the short axis to determine the at least one object information when the ratio is larger than a ratio threshold, wherein the object information is a coordinate position of at least one separated image.

11. The processing method as claimed in claim 7, further comprising:
calculating a long axis of the polygon image;
calculating an area of the polygon image;
calculating a ratio of the long axis to the short axis; and
separating the polygon image along the short axis to determine the at least one object information when the area is larger than an area threshold and the ratio is larger than a ratio threshold, wherein the object information is a coordinate position of at least one separated image.

12. The processing method as claimed in claim 11, wherein the ratio threshold is inversely correlated with the area.

13. A processing method of an object image for an optical touch system, the optical touch system comprising at least two image sensors configured to successively capture image frames looking across a touch surface and containing at least one object operating on the touch surface and a processing unit configured to process the image frames, the processing method comprising:
respectively capturing, using the image sensors, a first image frame looking across the touch surface and containing at least one object image at a first time;
respectively capturing, using the image sensors, a second image frame looking across the touch surface and containing at least one object image at a second time;
generating a polygon image according to the second image frames when the processing unit identifies that an area increment between the object image captured at the second time and the object image captured at the first time by a same image sensor is larger than a variation threshold; and
determining, using the processing unit, a short axis of the polygon image and at least one object information accordingly.

14. The processing method as claimed in claim 13, further comprising:
respectively generating two straight lines in a two dimensional space according to mapping positions of each of the image sensors and borders of the object image in the associated second image frames; and
calculating a plurality of intersections of the straight lines to generate the polygon image.

15. The processing method as claimed in claim 13, further comprising:
calculating an area of the polygon image; and
separating the polygon image along the short axis to determine the at least one object information when the area is larger than an area threshold, wherein the object information is a coordinate position of at least one separated image.

16. The processing method as claimed in claim 13, further comprising:
calculating a long axis of the polygon image;
calculating a ratio of the long axis to the short axis; and
separating the polygon image along the short axis to determine the at least one object information when the ratio is larger than a ratio threshold, wherein the object information is a coordinate position of at least one separated image.

17. The processing method as claimed in claim 13, further comprising:
calculating a long axis of the polygon image;
calculating an area of the polygon image;
calculating a ratio of the long axis to the short axis; and
separating the polygon image along the short axis to determine the at least one object information when the area is larger than an area threshold and the ratio is larger than a ratio threshold, wherein the object information is a coordinate position of at least one separated image.

18. The processing method as claimed in claim 17, wherein the ratio threshold is inversely correlated with the area.
